(19) United States
(12) Patent Application Publication
(10) Pub. No.: US 2006/0031555 A1
(43) Pub. Date: Feb. 9, 2006

(54) Data context switching in a semantic processor

(76) Inventors: Somsubhra Sikdar, San Jose, CA (US); Kevin Jerome Rowett, Cupertino, CA (US)

Correspondence Address: MARGER JOHNSON & MCCOLLOM, P.C., 210 SW MORRISON STREET, SUITE 400, PORTLAND, OR, 97204, US

(21) Appl. No.: 11/198,748

(22) Filed: Aug. 4, 2005

Related U.S. Application Data
(60) Provisional application No. 60/599,830, filed on Aug. 5, 2004.

(51) Int. Cl. G06F 15/16

(52) U.S. Cl. 709/231

(57) ABSTRACT

Embodiments of a multiple-parsing-context parser and semantic processor are shown and described. The described embodiments allow an input data stream to be parsed in multiple contexts, with the parser switching between contexts as the input data stream dictates. For instance, one embodiment allows a SONET input data stream, including multiple interleaved payloads and SONET transport overhead, to be parsed using multiple grammars, with control passing between the grammars and contexts in a single pass. This approach allows a reconfigurable semantic processor to serve different payload arrangements for a complex multiplexed SONET stream.

### REFERENCE TO RELATED APPLICATIONS

Copending U.S. patent application Ser. No. 10/351,030, titled “Reconfigurable Semantic Processor,” filed by Somsubhra Sikdar on Jan. 24, 2003, is incorporated herein by reference.

### FIELD OF THE INVENTION

This invention relates generally to digital semantic processors, and more particularly to methods and apparatus for switching parsing contexts while parsing a data stream.

### BACKGROUND OF THE INVENTION

SONET (Synchoronous Optical NETwork) refers to a widely used standard for digital communication across fiber-optic cables, using a hierarchy of several different line rates. The SONET standards (ANSI T1.105.x) define line rates as STS-N, where “STS” is an acronym for Synchronous Transport Signal and “N” is commonly one of 1, 3, 12, 24, 48, 192, and 768. The line rate of an STS-N signal is N×51.84 Mbps (million bits per second), transmitted as 8000 frames/second, the frame size growing proportionally with N. The following background description contains a brief introduction to SONET concepts and terminology that will be helpful in understanding the embodiments described later in the application.

Referring to FIG. 1, a portion of an exemplary SONET network 100 is illustrated. An STS terminal multiplexer 110 receives data on one or more non-SONET tributaries, such as Ethernet links, circuit-switched voice network data links, Asynchronous Transfer Mode (ATM) data links, etc. STS terminal MUX 110 places data from its tributaries into SONET STS-N frames, which are then directed across a SONET path to Path-Terminating Equipment (PTE) 120, which could be another STS terminal MUX or some other device that extracts the tributary data from the STS-N signal.

Other SONET devices can reside along the path between STS terminal MUX 110 and PTE 120. For instance, two add/drop multiplexers (ADMs) 130 and 140, and two repeaters 150 and 160 are shown in the path between STS terminal MUX 110 and PTE 120.

ADMs 130 and 140 multiplex lower-rate STS-N signals to a higher-rate STS-N signal and vice-versa. For instance, ADM 130 could multiplex four STS-3 lines to an STS-12 line, and/or could extract (drop) some STS-3 lines from an incoming STS-12 and replace (add) other STS-3 lines to produce an outgoing STS-12 line.

Repeaters such as 150 and 160 can be inserted in lines too long for a single long fiber to reliably carry the SONET signal between endpoints. The repeaters cannot modify the SONET payload, but merely retime and retransmit it.

Three different layer terminologies are also illustrated in FIG. 1. For a given data stream, an STS path layer exists from where the data is first placed in a SONET frame to where that data is removed from a SONET frame. A line layer exists over any SONET path segment where the payload is unchanged. A section layer exists between any SONET receiver/transmitter pair that share the same fiber.

A SONET link carries overhead bits for the path, line, and section layers. These overhead bits are referred to respectively as Path OverHead (POH), Line OverHead (LOH), and Section OverHead (SOH). SONET endpoints that are only section endpoints can generate and/or modify SOH, but cannot modify LOH or POH. Endpoints that are also line endpoints can additionally generate and/or modify LOH, but cannot modify POH. Path endpoints are the only endpoints allowed to create POH.

Overhead and payload occupy specific locations in a SONET frame. The general structure of a SONET frame 200 is illustrated in FIG. 2. Every STS-N frame contains 90N columns and nine rows of byte data, which are transmitted in raster fashion, left-to-right and top-to-bottom. The first 3N columns contain overhead data, and the last 87N columns contain what is referred to as a Synchronous Payload Envelope (SPE) 230. Within the first 3N columns, the first three rows contain SOH 210, and the last six rows contain LOH 220. The POH lies within the synchronous payload envelope, as will be described shortly.

FIG. 3 shows additional SONET frame detail 300 for two consecutive STS-1 frames K and K+1. The POH in an STS-1 frame occupies one column of the SPE, leaving the remaining 86 columns available to transmit input data. Rather than occupying a fixed location within the frame like the SOH and LOH, however, the POH can be defined with a first byte starting at any row, column location within the SPE. This capability exists primarily to allow circuit-switched data, which also has an 8000 frames/second format but is not necessarily in perfect synchronization with the SONET frame timing, to be more easily carried as a SONET payload.

The beginning location of the POH is actually specified by an offset stored in the first two bytes of the LOH, referred to herein as the “H1H2 pointer.” Path-Terminating Equipment (PTE) interprets the H1H2 pointer values to locate the beginning of the next POH first byte that follows the H1H2 pointer. For instance, an H1H2 pointer offset of 0 would indicate that the frame overhead begins at row 4, column 4, just to the right of the H1H2 pointer.

As illustrated in FIG. 3, the H1H2 pointer of frame K has an offset to row 5, about seven or eight columns into the SPE, where the first byte of the POH for frame K will be found. The data payload for SPE K begins immediately after the first byte of the POH for frame K, and in this instance continues down to the first part of row 5 of frame K+1. As illustrated, the POH first byte for frame K+1 follows immediately after the last byte of SPE K. This is not necessary, however, as frame K shows a slight shift between the frame K−1 POH and the frame K POH, as represented by the H1H2 pointer.

One of the types of data that can be carried in a SONET SPE is packet data, such as is commonly carried on well-known computer networks. The packets carried in a SONET frame sequence need not be arranged in any synchronous fashion with respect to the SONET frames. For instance, FIG. 4 shows an illustrative SPE K, with a data payload that begins with the terminal end of a Packet_{—}1 payload, followed by a Packet_{—}2 IP (Internet Protocol) header, TCP (Transmission Control Protocol) header, and payload, a Packet_{—}3 IP header, ARP (Address Resolution Protocol) header, and payload, a Packet_{—}4 IP header, UDP (Uniform Datagram Protocol) header, and the first portion of payload. Within the frame or consecutive frames carrying SPE K, normally once a row a POH byte interrupts the packet data stream, as well as SOH and LOH bytes (not shown in FIG. 4). The PTE receiving this SONET stream is expected to remove the SONET overhead bytes and output just the header and payloads from the SPEs.

A further complication in the SONET hierarchy lies in the ability within the SONET framework to build a higher-level SONET frame stream from different combinations of lower-level SONET frame streams. For instance, a segment of a SONET network 500, illustrated in FIG. 5, shows one way in which an STS-12 stream can be constructed from six STS-1 streams and two STS-3c concatenated streams (a concatenated STS-Nc frame, designated by the “c” prefix, has a similar SPE structure as an STS-1 frame, but with more columns, and also contains a few LOH differences, as is well-known by those skilled in SONET networking).

In SONET network segment 500, a first STS-3 multiplexer (MUX) 510 combines three STS-1 streams A, B, and C to create an STS-3 stream AA. A second STS-3 MUX 520 combines three other STS-1 streams D, E, and F to create another STS-3 stream DD. STS-12 MUX 530 creates an STS-12 stream AAA by combining STS-3 streams AA and DD with two STS-3c concatenated streams BB and CC.

The overall frame structure 600 of a frame from STS-3 stream AA is illustrated in FIG. 6. The first 9 columns contain SOH and LOH bytes, including H1H2 bytes for each of the individual lower-rate SPEs multiplexed in the frame. The H1H2 pointers from STS-1s A, B, and C are copied into three consecutive byte-interleaved H1H2 fields in the LOH section of the frame structure. Each H1H2 pointer indicates a respective offset to the first byte of its POH. Any arrangement of starting points for the three STS-1 POH columns is allowable, with each lying somewhere in the 87 columns of the STS-3 SPE that correspond to the correct STS-1 stream.

The next 261 columns in frame structure 600 contain STS-3 payload, consisting of byte-interleaved content from the three received STS-1 SPEs. For instance, column 10 of frame structure 600 contains column 4 from an STS-1 stream A frame, column 11 contains column 4 from an STS-1 stream B frame, and column 12 contains column 4 from an STS-1 stream c frame. This byte-interleaved pattern then repeats for column 5 of each of the three STS-1 streams, and so on up to column 87 of the three STS-1 streams, which appear respectively in columns 268, 269, and 270 of the STS-3 frame.

Although the frame structure for STS-12 stream AAA is not illustrated, STS-12 multiplexer 530 takes four input STS-3 and/or STS-3c streams and byte-interleaves them in the same manner as just described. The output pattern for the STS-12 SPE in this example would repeatedly byte-interleave the four STS-3 input streams with the pattern AA, BB, CC, DD, AA, BB, . . . , CC, DD. Expanding this pattern to include the embedded STS-1s per FIG. 6, the STS-12 SPE byte-interleave pattern looks like A, BB, CC, D, B, BB, CC, E, C, BB, CC, F, repeated along each row.

Conventionally, a set of demultiplexers exactly mirroring the multiplexers shown in FIG. 5 is required to terminate a path with the STS-12 frame structure. From FIGS. 5 and 6 and the preceding description, it can be appreciated that other combinations of STS-1, STS-3, and/or STS-3c frames can form an STS-12 frame, or the STS-12 frame can itself be an STS-12c frame.

An STS-48 frame is created similarly to an STS-12 frame, except in place of the 4:1 multiplexer 530 of FIG. 5, a 16:1 multiplexer is used to byte-interleave 16 STS-3 and/or STS-3c frames. Other combinations of lower-order STS streams are possible.

### BRIEF DESCRIPTION OF THE DRAWING

The invention may be best understood by reading the disclosure with reference to the drawing, wherein:

FIG. 1 contains a network diagram for an exemplary path of a SONET network;

FIG. 2 illustrates a generalized SONET frame structure;

FIG. 3 shows particulars of a SONET STS-1 framing;

FIG. 4 illustrates an STS-1 SPE, showing one way in which packet data may be transmitted over a SONET STS-1 path;

FIG. 5 shows one possible arrangement of SONET multiplexers useful in generating an STS-12 frame;

FIG. 6 illustrates the general payload division for STS-3 frames generated by the STS-3 multiplexer elements shown in FIG. 5;

FIG. 7 illustrates the general layout for one embodiment of a semantic processor according to an embodiment of the present invention;

FIG. 8 shows one possible implementation of a reconfigurable input buffer useful with SONET embodiments of the present invention;

FIG. 9 contains a block diagram for the parser and related components of the semantic processor shown in FIG. 7;

FIG. 10 shows the format of STS-3 frames after removing byte-interleaving with the input buffer of FIG. 8; and

FIG. 11 contains one row of de-interleaved STS-3 frame data extracted from FIG. 10, showing contextual switches in the byte stream for that row.

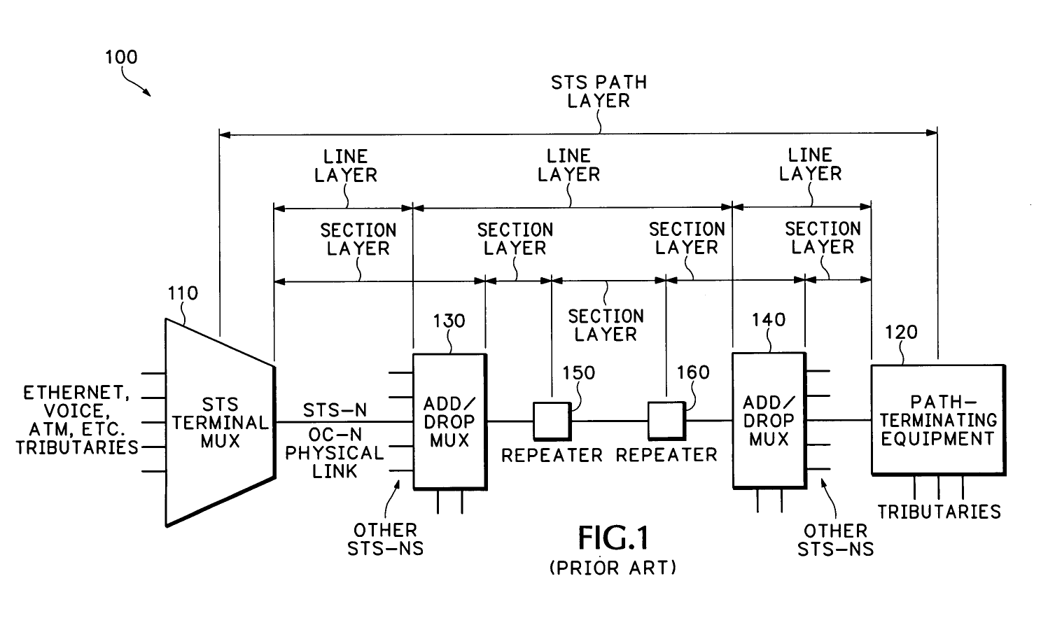

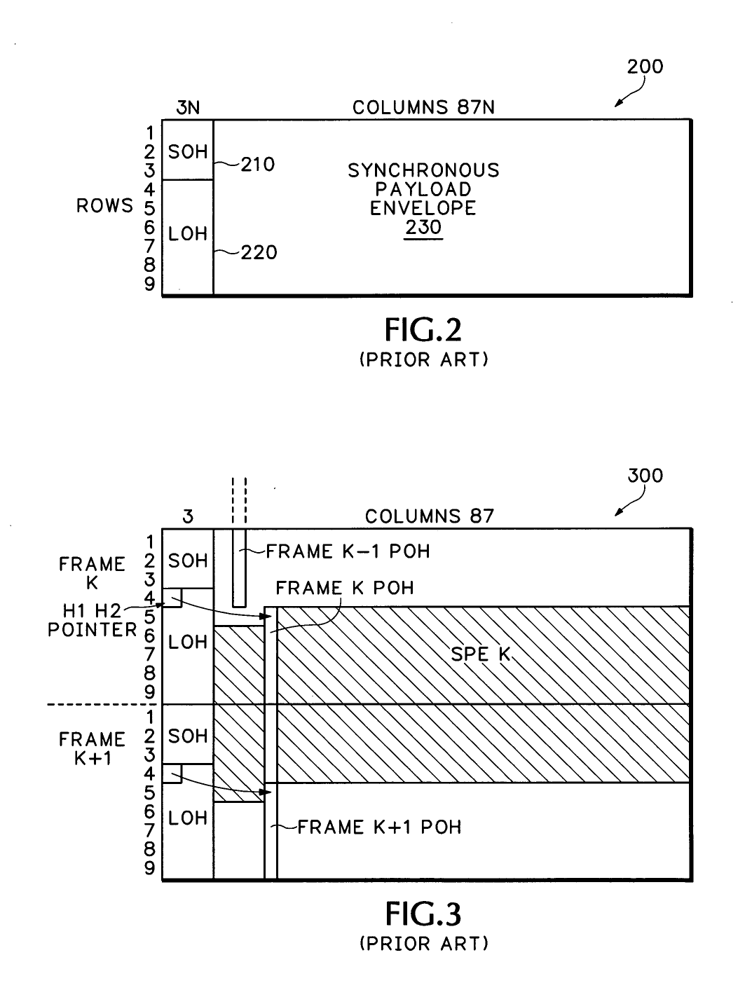

### DETAILED DESCRIPTION OF THE PREFERRED EMBODIMENTS

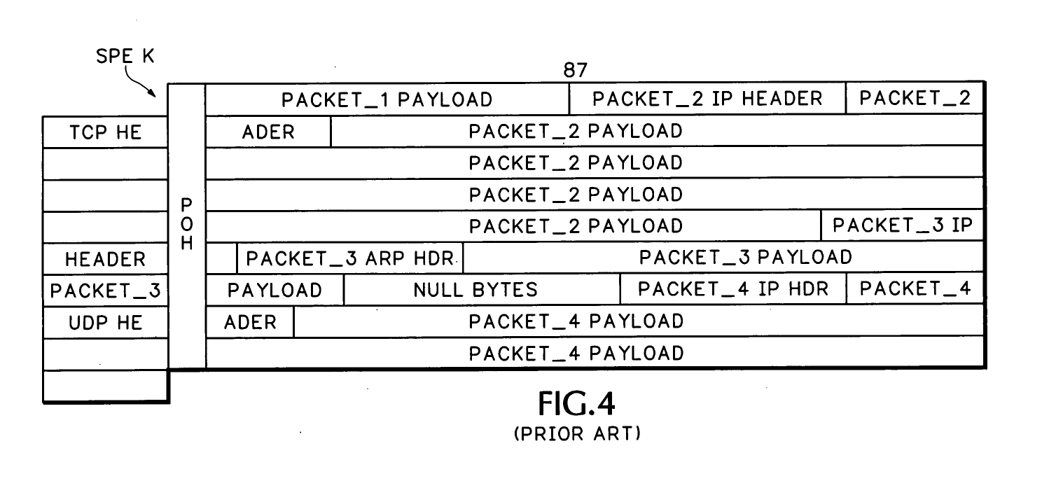

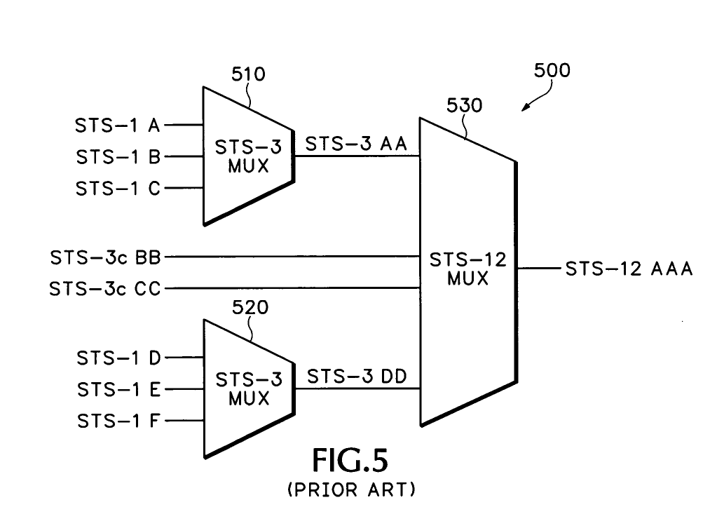

In the example of FIGS. 4-6, eight separate packet payloads are SONET-framed and multiplexed onto a single STS-12 line. Traditionally, an STS-12 demultiplexer, two STS-3 demultiplexers, and eight packet processors would be required to terminate the paths created by the networking elements shown in FIG. 5. A different arrangement of termination hardware would be required for a different formulation of STS-12 framing. Other arrangements of termination hardware would be required, e.g., for formulations of STS-48 framing.

It would be desirable for a single device to be able to handle different STS-3, STS-12, STS-48, etc., and/or handle both STS demultiplexing and payload processing for an STS data stream. It has now been discovered that, with certain enhancements, a semantic processor having a direct execution parser can be configured to handle such tasks. For instance, the following description contains semantic processor embodiments and methods with the potential to receive a byte-interleaved STS frame structure such as that previously described, and completely interpret and process that structure, including the packet data carried in the SPE if desired. As an added benefit, at least some described embodiments can be reconfigured, by loading different parser grammar, to handle other STS frame structures and/or payload content.

One difficulty in directly parsing a received SONET frame structure is that the byte stream represents data from many different parsing contexts, intermixed in a fashion that typically changes parsing contexts at each received byte. SONET processing occurs in at least one context, and could be divided into section, line, path, and framing contexts. Each atomic STS-1 or STS-Nc payload stream also uses a different context.

The arrangement of the contexts also depends on how the STS-N stream is created, and also changes over time as the POH columns are allowed to shift. Accordingly, for general SONET processing the order of received contextual information cannot be predicted readily more than a frame in advance.

This problem of multiple parsing contexts in a single data stream is not unique to SONET parsing. Other networking streams exist that can be parsed more easily when parsing is not constrained to a single, linear context. Because SONET is believed to represent a difficult example of such a stream, the described embodiments focus on a SONET implementation. Those skilled in the art will recognize how multiple-context parsing can be applied to other parsing problems. Those skilled in the art will also recognize that not every multiple-context parser will need some of the functionality that is specific to SONET, such as a byte de-interleaver and POH counters.

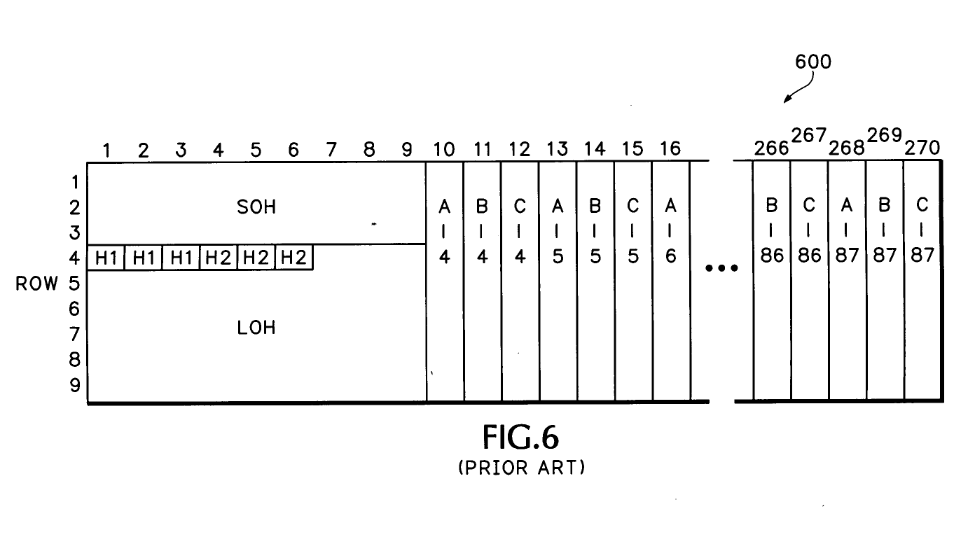

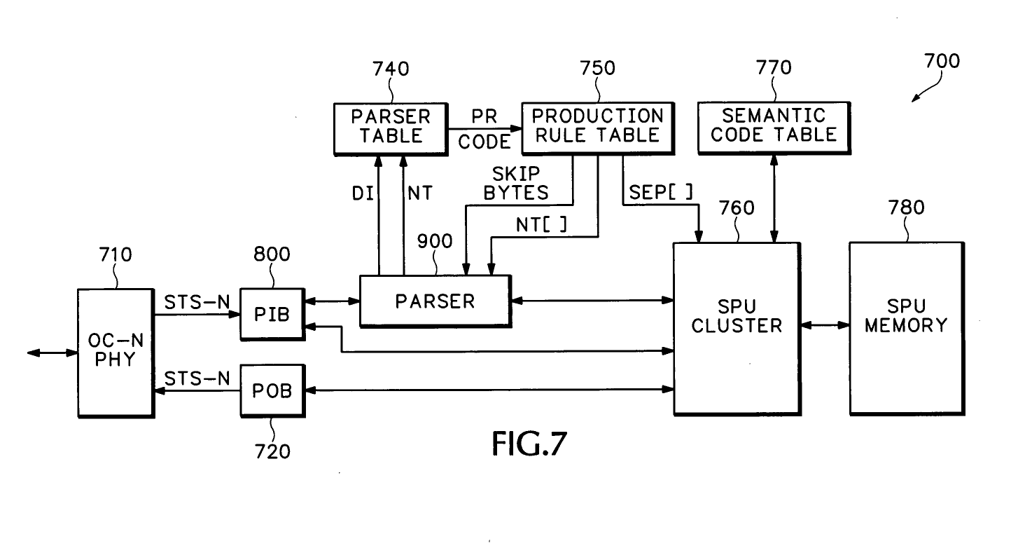

The semantic processor embodiment illustrated in FIGS. 7-9 is capable of configuration to properly parse SONET data, such as that contained in FIG. 6, using multiple simultaneous parsing contexts.

Turning first to FIG. 7, a semantic processor embodiment 700 is illustrated. An OC-N PHY (Optical Carrier STS-N physical interface) 710 connects semantic processor 700 to a pair of SONET fiber-optic carriers (not shown). The inbound STS-N stream is optically detected by PHY 710 and electrically transmitted to a Packet Input Buffer (PIB) 800. The outbound STS-N stream is electrically transmitted from a Packet Output Buffer (POB) 730 to PHY 710 for laser modulation on an outbound SONET fiber.

A parser 900 is connected to receive data input from PIB 800. A Parser Table (PT) 740 stores parsing data particular to the input that semantic processor is configured to parse. A Production Rule Table (PRT) 750 stores grammatical production rules particular to the input that semantic processor is configured to parse. A Semantic Code Table (SCT) 770 stores microcode segments for a SPU cluster 760, which preferably contains multiple semantic processing units capable of executing the microcode segments when so instructed, e.g., by parser 900 or another SPU. A SPU memory 780 stores data needed by the SPU, such as session contexts, packet data currently being processed, etc. Preferably, PT 740, PRT 750, and SCT 770 are implemented with programmable on-chip memory, and SPU memory 780 is implemented with a cached DRAM external memory.

In operation, PIB 800 receives input data, such as a sequence of Ethernet frames, SONET frames, Fibre Channel frames, etc., from an appropriate PHY, such as the OC-N PHY 710 of FIG. 7. The frame data is retrieved from PIB 800 by parser 900 and/or SPU cluster 760, as directed by the grammatical production rules and the SCT microcode.

When parser 900 receives input data from PIB 800, it can do one of two things with the input data. First, it can literally match input data symbols with literal (“terminal”) symbols stored in the production rules. Second, and generally more common, parser 900 can “look up” additional production rules for the data input symbols, based on the current data input symbol(s) and a current production (“non-terminal” or “NT”) symbol. It is noted that terminal symbol matching can generally be performed using either production rule terminal symbols or parser table terminal match values.

When parser 900 is directed by the grammar to look up an additional production rule, parser 900 supplies one or more current data input (DI) symbols and non-terminal (NT) grammar symbols to parser table 740. Based on the (NT, DI) pairing supplied by the parser, parser table 740 issues a corresponding PR code to production rule table (PRT) 750. In some embodiments, parser table 740 is implemented with a Ternary Content-Addressable Memory (TCAM) consisting of entries of the form (NT, DI_match). Multiple (NT, DI_match) entries can exist for the same NT symbol and different DI_match values. The TCAM will return, as the PR code, the address of the entry with the correct NT value and DI_match value that matches the supplied data input DI. Because the TCAM allows individual bits or bytes in each TCAM entry to be set to a “don't care” value, each TCAM entry can be tailored to respond to the bits or bytes in DI that matter for the current production rule.

When parser table 740 locates the correct PR code, the code is passed to production rule table 750. PRT 750 locates a production rule corresponding to the PR code, and outputs the production rule. Although the production rule can contain whatever is desired, in FIG. 7 the production rule contains an array of up to M non-terminal (and/or terminal) symbols NT[ ], an array of up to R Semantic Code entry Points SEP[ ], and a SkipBytes value. The symbol array NT[ ] directs the parser as to what input will now be expected, based on the latest parsing cycle. The SkipBytes value directs the parser as to how many, if any, of the DI bytes were consumed by the latest parsing cycle, and can therefore by discarded. The semantic code entry point array SEP[ ] directs the SPU cluster 760 as to any processor tasks that should be performed based on the latest parsing cycle.

Based on a SEP supplied from PRT 750, SPU cluster 760 loads and executes a code segment to perform a task. For instance, a SPU could be directed to move the payload portion of an input packet from PIB 800 to SPU memory 780 and manipulate that payload portion in some fashion. SPU cluster 760 can also create output packet/frames and supply them to POB 720 for outbound transmission at PHY 710.

The preceding introduction to operation of one semantic processor embodiment is sufficient to allow understanding into the interoperation of PIB 800 and parser 900, which will be discussed in detail regarding multiple-context SONET processing, with the other blocks of an exemplary semantic processor. For further explanation of the other blocks of FIG. 7, the reader is respectfully referred to co-pending U.S. patent application Ser. No. 10/351,030, which was incorporated herein by reference.

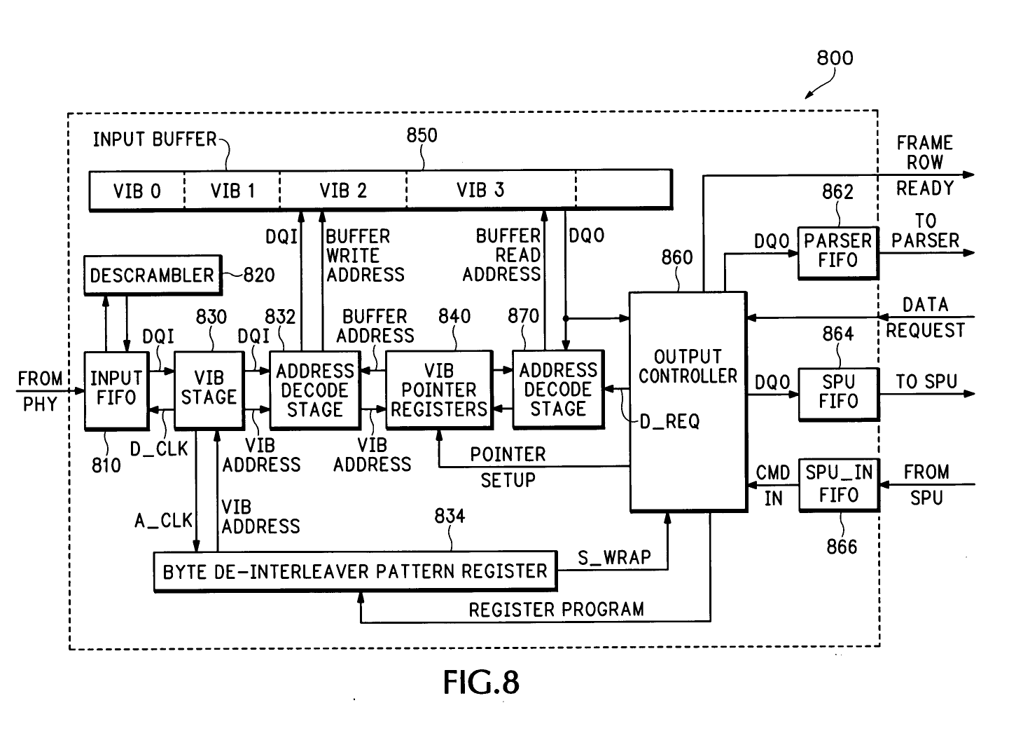

Although parser 900 could conceivably operate directly on a byte-interleaved SONET stream, context-switching on every byte boundary during high-speed operation could waste a prohibitive number of parser cycles. Accordingly, FIG. 8 illustrates one embodiment of PIB 800 that is capable of partially de-interleaving received SONET frames.

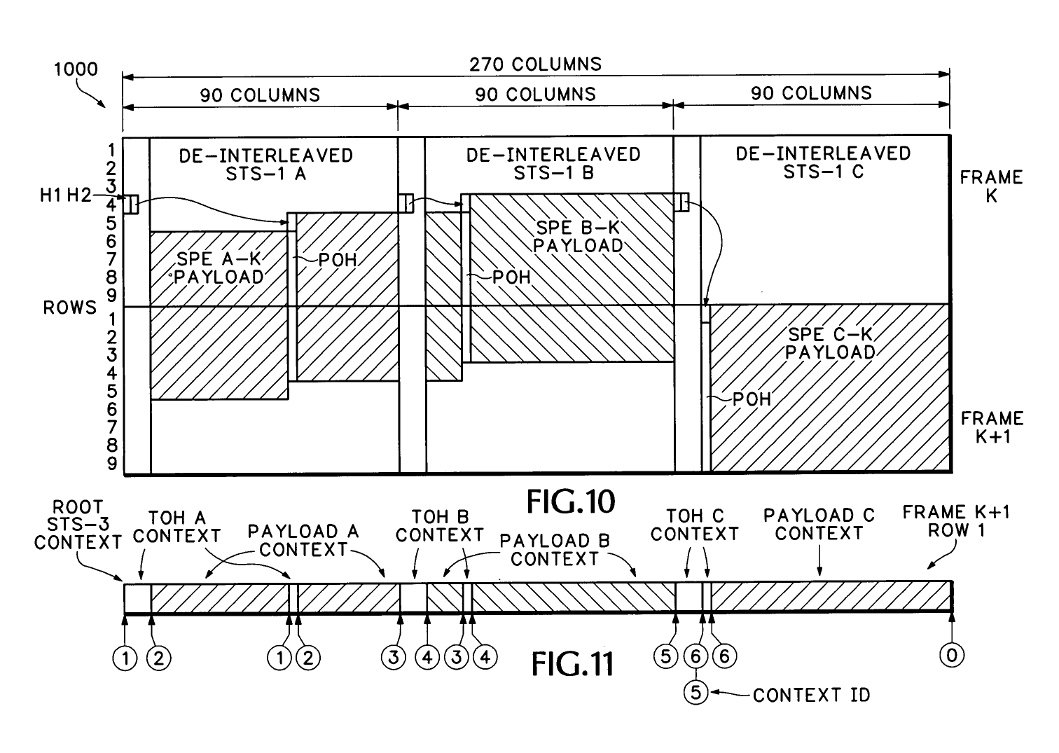

The goal for this input buffer embodiment is to, on a row-by-row basis, de-interleave the byte-interleaved SPEs present in an STS-N stream. Reference will be made to FIG. 10, which illustrates the desired output of PIB 800 for STS-3 frames consisting of three byte-interleaved STS-1s A, B, and C (see FIG. 6). Optionally, the SOH and FOH columns can be “de-interleaved” as well with a parser grammar written so as to expect such a structure, or specific overhead sections such as the H1H2 pointers can be de-interleaved.

Frame structure 1000 of FIG. 10 would apply to the line STS-3 AA in FIG. 5. In frame structure 1000, nine columns of SOH and LOH and 261 columns of STS-3 SPE exist, just like in frame structure 600 of FIG. 6. After byte de-interleaving, however, the 261 columns of STS-3 SPE are divided into three consecutive 87-column sections, corresponding respectively to STS-1s A, B, and C of FIG. 5. It is noted that frame structure 1000 can be created with about a 2/3-row de-interleave latency, as the STS-1 A payload section for each row cannot be completed until three bytes from the end of that row when the last STS-1 A byte is received.

Referring back to FIG. 8, the blocks of PIB 800 will now be explained as to their function in transforming the frame structure of FIG. 6 to the frame structure of FIG. 10. PIB 800 is preferably reconfigurable, however, to perform no de-interleaving or de-interleaving for a different interleaved structure.

An Input FIFO 810 receives an STS-N data stream from an OC-N PHY. Input FIFO 810 detects framing bytes within the STS-N data stream in order to frame-sync. Input FIFO 810 then coordinates with a standard SONET descrambler 820 to descramble the portions of each SONET frame that were scrambled prior to transmission. The DQI output of input FIFO 810 outputs a byte DQI of descrambled SONET frame data each time it receives a data clock signal D_CLK from a VIB (Virtual Input Buffer) stage 830.

VIB stage 830 has the task of matching each byte of DQI with a corresponding VIBAddress entry from a programmable Byte De-Interleaver Pattern (BDIP) register 834. VIB stage 830 obtains one VIBAddress entry from BDIP register 834, and then BDIP register increments, each time VIB stage 830 asserts an address clock signal A_CLK.

BDIP register 834 contains a mapping for one row of SONET frame data to a group of VIB input buffers in an input buffer 850. For instance, the pattern for frame structure 600 of FIG. 6 can be 275 entries with the pattern:
&,1,2,3,1,2,3,1,2,3, . . . ,1,2,3,1,2,3, 1,&,2,&,3,&@,
   where “&” and “@” signify special control characters. In this example, VIB 0 is not assigned to hold any bytes, VIB 1 is assigned to hold STS-1 A bytes, VIB 2 is assigned to hold STS-1 B bytes, and VIB 3 is assigned to hold STS-1 C bytes. The control character “&” is not matched with a DQI by VIB stage 830, but is written to the same VIB as the last DQI, signifying “end of row” for that particular VIB. The control character “@” tells BDIP register that it has reached the end of a frame row, causing BDIP register 834 to reset its read pointer to the head of the register and assert the signal S_Wrap to alert an output controller 860 that a complete frame row has been (or will be in a few more clock cycles) de-interleaved and is ready for output.

An address decode stage 832 receives DQI/VIBAddress pairs and &/VIBAddress pairs from VIB stage 830. Address decode stage 832 supplies the VIBAddress to VIB pointer registers block 840, which returns a physical buffer address corresponding to the VIBAddress. Address decode stage 832 writes the DQI or “&” to the physical buffer address in input buffer 850.

The VIB pointer registers 840 are configured to operate as a plurality of ring buffer pointer registers, each storing a physical StartAddress, a physical EndAddress, a WritePointer, and a ReadPointer. When address decode stage 832 supplies a VIBAddress to VIB Pointer Registers 840, the correct WritePointer is retrieved and returned to address decode stage 832 as a physical buffer address. The WritePointer is then incremented, and reset to StartAddress when WritePointer reaches EndAddress.

On the output side of PIB 800, an output controller 860 interfaces with a parser through a FrameRowReady output signal, a parser output FIFO 862, and a DataRequest input. Output controller 860 also interfaces with a SPU or SPU cluster through a SPU output FIFO 864 and a SPU_IN FIFO 866. The operation of both interfaces will be described in turn.

When output controller 860 receives an S_Wrap signal from BDIP register 834, controller 860 asserts FrameRowReady to the parser. Output controller 860 can then respond to DataRequest inputs from the parser by transmitting DQO (DQ Output) values to the parser through parser FIFO 862.

Output controller 860 loads parser FIFO 862 by issuing D_REQ (data request) signals to an address decode stage 870. Address decode stage 870 is initially set internally to read out of VIB 0. Each time it receives a D_REQ signal, address decode stage requests the current ReadPointer for VIB 0 from VIB pointer registers 840. Address decode stage 870 supplies this ReadPointer as a buffer read address to input buffer 850 and receives a DQO. Meanwhile, VIB Pointer Registers 840 increment ReadPointer, and reset it to StartAddress when ReadPointer reaches EndAddress.

When address decode stage 870 receives a DQO from input buffer 850 that contains an “&” control character, it knows that it has reaches the end of that virtual buffer's input for the current SONET row. Accordingly, address decode stage 870 increments its internal VIBAddress from VIB 0 to VIB 1 and begins reading from VIB 1 on the next D_REQ. This same behavior is repeated as an “&” is reached in each VIB, until the “&” in the last allocated VIB is reached. At that point, the internal VIBAddress is reset to VIB 0 in preparation for reading the next frame row.

DQO values can be read out to a SPU in similar fashion through SPU FIFO 864, based on commands received from a SPU at a SPU_IN FIFO 866. It is also noted that “burst” read or skip forward commands can be efficiently implemented by storing pointers to the next few “&” characters in each VIB in the VIB pointer registers. Multiple consecutive DQO values can then be read at once as long as they do not read past the next “&” in the current VIB.

SPU_IN FIFO 866 can also be used to program PIB 800 at runtime. By issuing an appropriate CMD_IN, a SPU can instruct output controller 860 to receive a pattern and load that pattern to BDIP register 834 through the RegisterProgram signal interface. A SPU can also instruct output controller 860 to configure VIB StartAddress and EndAddress values for each active VIB in VIB Pointer Registers 840 and then initialize the ReadPointer and WritePointer values. A SPU can also instruct output controller 860 to configure input FIFO for the appropriate frame size and alignment character sequence, and load a seed to descrambler 820.

VIB stage 830 and/or Address Decode stage 832 can be pipelined as necessary to achieve an appropriate throughput for designed STS-N data rates. BDIP register 834 is designed with a size sufficient to hold a row mapping for the largest STS-N of interest. Input buffer 850 is designed with a size sufficient to hold at least two rows of the largest STS-N of interest. VIB pointer registers 840 are designed with enough pointer register sets to de-interleave the largest STS-N of interest were that STS-N composed entirely of STS-1s (for instance, 49 pointer register sets could be included to handle de-interleaving for any STS-48).

For non-byte-interleaved input, much of the functionality just described could be bypassed with a simple single-ring-buffer interface to input buffer 850. Optionally, the described hardware can be configured with a continuous VIB 0 pattern in BDIP register 834 and a VIB 0 register set with a StartAddress set to the left end of input buffer 850 and an EndAddress set to the right end of input buffer 850.

Given the STS-3 example of FIG. 6 and the description of PIB 800 operation, PIB 800 can produce the modified SONET frame structure 1000 of FIG. 10 to parser 900 using three virtual input buffers and the exemplary pattern stored in BDIP register 834. Rather than the byte-interleaved STS-3 frame structure, frame structure 1000 is rearranged to place the 90 columns corresponding to STS-1 A TOH and SPE columns in the first 90 columns of the frame, followed by all STS-1 B columns starting in column 91, followed by all STS-1 C columns starting in column 181. Other column rearrangements are possible, as long as the parser grammar is configured to expect what is received.

Given the rearranged STS-3 frame structure of FIG. 10, parser 900 will still use at least four different contexts to process frame structure 1000. As illustrated in FIG. 11, seven contexts are used. Context 0 is the root context for the input stream. Contexts 1, 3, and 5 are used to parse the TOH bytes for STS-1 A, B, and C, respectively. Contexts 2, 4, and 6 are used to parse the payloads for STS-1 A, B, and C, respectively.

FIG. 11 repeats only frame K+1, row 1 from the rearranged STS-3 example of FIG. 10. The first three bytes can be parsed in context 1, an STS-1 parsing context with grammar designed to recognize the alignment and J0 characters appearing in SOH row 1.

The next 87 bytes are part of the STS-1 A payload context, and contain a POH byte and 86 payload bytes, which in this example are considered to be packet data (headers and/or packet payload). The actual location of the POH byte within these 87 bytes is part of context 1, and must be remembered from an H1H2 LOH field that was previously parsed. And the remaining 86 bytes in all likelihood do not start with the first byte of a packet, but could be a continuation of a previously unfinished packet parsing context that must be revisited.

The same observations hold for the middle 90 bytes and the last 90 bytes, respectively representing STS-1 B (contexts 3 and 4) and STS-1 C (contexts 5 and 6). The packet data in these last two byte segments will, for this example, represent different parsing contexts than the packet data in the first 87 bytes of SPE data. And the H1H2 values for these last two byte segments will indicate POH locations, within the 90 byte segments, unique to those segments.

At the end of the row shown in FIG. 11, the context shifts back to context 0, the root STS-3 context. Accordingly, during the processing of the exemplary modified STS-3 row in FIG. 11, a direct execution parser according to an embodiment of the invention could switch parsing contexts thirteen times. The switching itself is controlled by the modified STS-3 context, even when that context is not “active.”

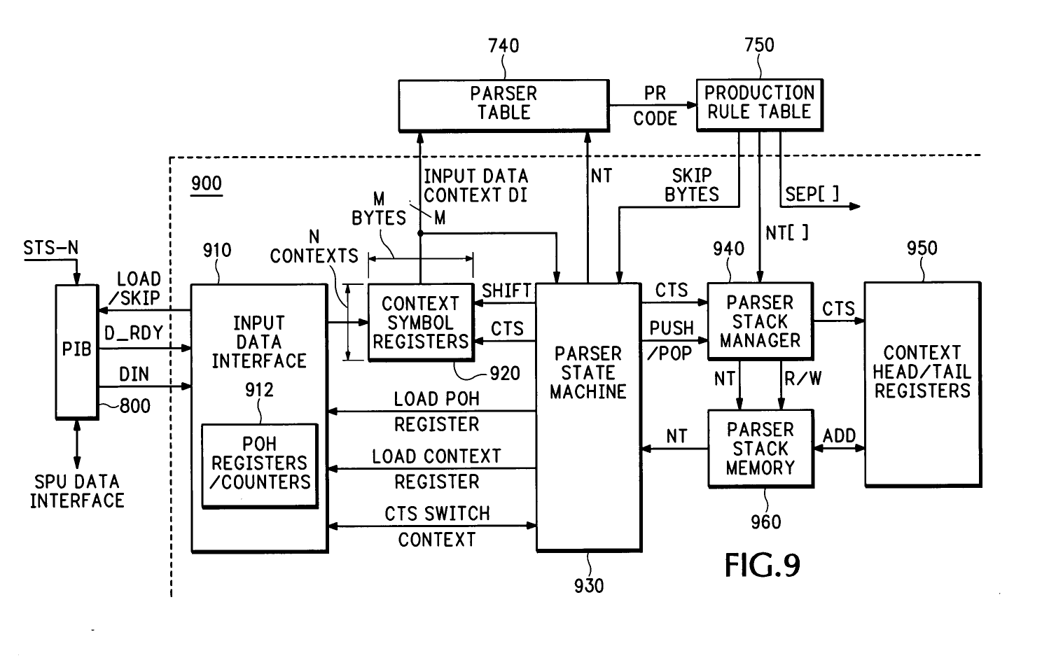

A block diagram of a parser embodiment 900 is shown in FIG. 9, along with PIB 800, parser table 740, and production rule table 750. Parser 900 comprises an input data interface 910, a bank of context symbol registers 920, a parser state machine 930, a parser stack manager 940, a bank of context head/tail registers 950, and a parser stack memory 960.

Input data interface 910 communicates with PIB 800. When PIB 800 asserts D_RDY to interface 910, interface 910 is allowed to send load or skip requests to PIB 800 until D_RDY is deasserted, signaling the end of a SONET frame row. In response to load requests, PIB 800 supplies input data to interface 910 over bus DIN.

Input data interface 910 requests data from PIB 800 in response to requests from parser state machine 930 (although interface 910 may cache not-yet-requested data as long as it responds correctly to external requests). Parser state machine 930 maintains the ID for the current context on the CTS bus. Whenever parser state machine 930 instructs input data interface to load input data to context symbol registers 920, row byte counters in a POH registers/counters 912 block, internal to input data interface 910, track the number of bytes read to that context.

Within register/counter block 912, two count registers are allocated for each context. The first, the previously mentioned row_byte_counter, counts the number of bytes read to the current context on the current frame row. The row byte counters for all contexts are reset each new frame row. The second, the SPE byte counter, counts the number of bytes read to the current context in the current SPE. The SPE byte counter counts are reset after each SPE is read in.

Four comparison registers are also allocated for each context in register/counter block 912. A row_count_max register defines the maximum number of symbols that should be read to that context on the current row, for instance 86 symbols for an STS-1 row, excluding overhead bytes. A SPE_count_max register defines the maximum number of symbols that should be read to that context for the current SPE, for instance 774 for an STS-1 SPE, excluding overhead bytes. A current_POH_pointer maintains a value for the column location of the POH in the current SPE, and a next_POH pointer maintains a value for the column location of the POH in the next SPE. The row_count_max register and SPE_count_max registers are loaded when parser table 740 and production rule table 750 are configured for the current input stream. The current_POH_pointer and next_POH_pointer are dynamic, and set by the load_POH_register signal from parser state machine 930.

A enable flag register also exists for each context; the value of the enable flag register determines whether the registers and counters for a particular context are enabled. When the registers and counters for a particular context are enabled and that context is active, the row byte and SPE byte counters increment as data is transferred to the context symbol registers 920. When the row byte counter value reaches the row_count_max register value, input data interface 910 signals a level-decrement grammar context switch to parser state machine 930 and stops any pending transfer to the current context. When the row byte counter value reaches the current_POH_pointer value, input data interface 910 signals a level-decrement grammar context switch to parser state machine 930 and stops any pending transfer to the current context. Also, when the SPE byte counter value reaches the SPE_count_max value, the next_POH_pointer is loaded to the current_POH_pointer, and the input data interface 910 skips bytes if necessary in the current row until it reaches the next_POH_pointer.

One final task of registers/counters 912 is to determine when the transmitter has signaled a positive or a negative byte stuff. A positive byte stuff is signaled by the transmitter inverting bits 7, 9, 11, 13, and 15 of the POH pointer, and a negative byte stuff is signaled by the transmitter inverting bits 8, 10, 12, 14, and 16 of the POH pointer. When parser state machine 930 loads a next_POH_pointer for a context, registers/counters 912 compare the next_POH_pointer value to the current POH_pointer value and signal a positive or negative byte stuff condition, as described, to parser state machine 930. Also, for a positive byte stuff, the row byte counter is incremented by one; for a negative byte stuff, the row byte counter is decremented by one.

Context symbol registers 920 store context symbols for each of N potential contexts. For instance, when context 2 is an IP packet context, context 2 may be exited and re-entered several times per packet before parsing is completed on that packet. Context symbol register 920 maintains the current symbol state in the interim for the suspended contexts. When register 920 receives input bytes from input data interface 910, it stores them to the context register indicated on the CTS bus. Further, the value output on the DI bus to parser state machine 930 and parser table 740 is the value contained in the context register indicated on the CTS bus. Context symbol register 930 also preferably maintains two values for each context symbol register, indicating how many of its input bytes are valid, and how many input bytes have been requested but not filled.

Parser state machine 930 coordinates operation of the other elements of parser 900, and signals all context switches. As previously mentioned, byte counter comparisons may in some circumstances signal the parser state machine to switch contexts. The example below will also demonstrate how context switches can be initiated by the grammar itself, when parser state machine receives special non-terminals that instruct it to switch contexts. Except for the context-switching function described herein, parser state machine 930 can in some embodiments function similarly to the parser state machine described in copending U.S. patent application Ser. No. 10/351,030.

Parser stack manager 940 performs pushes and pops of parser stack symbols to parser stack memory 960. In the illustrated embodiment, the CTS bus value is used by parser stack manager 940 to access a set of head/tail registers 950 for each context. The head/tail registers 950 contain two pointers for each context: a head pointer, which contains the address in parser stack memory 960 for the top-of-stack symbol for that context; and a tail pointer, which contains the address in parser stack memory 960 for the bottom-of-stack symbol for that context. When symbols are pushed to a context, the head pointer is incremented. When symbols are popped to a context, the head pointer is decremented.

The operation of and cooperation between the elements of parser 900 will be described further by example, with reference to the de-interlaced STS-3 frames of FIG. 10.

Before parser 900 begins processing input from an STS-N stream, it can be specifically configured for the appropriate number of parsing contexts for that stream. Preferably, however, contexts are available and ready for use already, with movement between them directed by the grammar, with the STS-3 grammar being a “root” grammar and the required number of “branch” grammars for the input port.

For instance, the STS-3 root frame grammar for the illustrated embodiment can be defined as:

| | |
|---|---|
| $STS-3 Stream | := TOF STS-3_DI_Frame |
| $STS-3_DI_Frame | := @@L+1 CTS @@L+3 CTS @@L+5 CTS \ \*1 |
| | @@L+1 CTS @@L+3 CTS @@L+5 CTS \ \*2 |
| | @@L+1 CTS @@L+3 CTS @@L+5 CTS \ \*3 |
| | @@L+1 CTS @@L+3 CTS @@L+5 CTS \ \*4 |
| | @@L+1 CTS @@L+3 CTS @@L+5 CTS \ \*5 |
| | @@L+1 CTS @@L+3 CTS @@L+5 CTS \ \*6 |
| | @@L+1 CTS @@L+3 CTS @@L+5 CTS \ \*7 |
| | @@L+1 CTS @@L+3 CTS @@L+5 CTS \ \*8 |
| | @@L+1 CTS @@L+3 CTS @@L+5 CTS \*9 |
| $TOF | := CTL_NewFrame SKIP_1_BYTE |
| $CTS | := CTL_ContextShift SKIP_1_BYTE |
| $A1 | := 0xF6 |
| $A2 | := 0x28 |

In the above grammar, the STS-3 stream is defined as a top of frame (TOF) symbol, followed by a de-interlaced STS-3 frame. The TOF grammar includes an instruction to “SKIP_{—}1_BYTE,” in other words, to consume the CTL_NewFrame symbol from the symbol register 920 for context 0.

The STS-3 de-interlaced frame definition includes nine repetitions of a common pattern “@@L+1 CTS @@L+3 CTS @@L+5 CTS.” The CTS grammar looks for and consumes a CTL_ContextShift character, which was inserted in the incoming data stream between virtual input buffer segments by the PIB. The @@L+n grammar signifies a special parser directive to shift contexts, with relation to the present context, upwards n contexts. Thus on each row of a de-interlaced frame, the root grammar switches three times, to an STS-1 grammar, as defined below.

The STS-1 grammar processes STS-1 de-interlaced input on nine rows, for instance as follows:

| | |
|---|---|
| $STS-1_Frame | := STS-1_Fr_row1 STS-1_Fr_row2 STS-1_Fr_row3 \ |
| | STS-1_Fr_row4 STS-1_Fr_row5 STS-1_Fr_row6 \ |
| | STS-1_Fr_row7 STS-1_Fr_row8 STS-1_Fr_row9 |
| $STS-1_Fr_row1 | := STS-1_TOH_row1 STS-1_SPE_row |
| $STS-1_Fr_row2 | := STS-1_TOH_row2 STS-1_SPE_row |
| $STS-1_Fr_row3 | := STS-1_TOH_row3 STS-1_SPE_row |
| $STS-1_Fr_row4 | := STS-1_TOH_row4 STS-1_SPE_row |
| $STS-1_Fr_row5 | := STS-1_TOH_row5 STS-1_SPE_row |
| $STS-1_Fr_row6 | := STS-1_TOH_row6 STS-1_SPE_row |
| $STS-1_Fr_row7 | := STS-1_TOH_row7 STS-1_SPE_row |
| $STS-1_Fr_row8 | := STS-1_TOH_row8 STS-1_SPE_row |
| $STS-1_Fr_row9 | := STS-1_TOH_row9 STS-1_SPE_row |
| $STS-1_SPE_row | := @@L++ POH @@L++ @@Lroot |
| $POH | := octet |
| $STS-1_TOH_row1 | := A1 A2 J0 SKIP_3_Bytes |
| $J0 | := octet |
| $STS-1_TOR_row2 | := B1 E1 F1 SKIP_3_Bytes |
| $B1 | := octet |
| $E1 | := octet |
| $F1 | := octet |
| $STS-1_TOH_row3 | := D1_D2_D3 SKIP_3_Bytes |
| $D1_D2_D3 | := octet octet octet |
| $STS-1_TOH_row4 | := J1_Pointer \ |
| | Neg_Stuff \| Pos_Stuff \| No_Stuff |
| $Pos_Stuff | := Pos_Shift SKIP_4_Bytes |
| $Neg_Stuff | := Neg_Shift SKIP_2_Bytes |
| $No_Stuff | := No_Shift SKIP_3_Bytes |
| $J1_Pointer | := @@Xferpointer |
| $STS-1_TOH_row5 | := B2 K1_K2 SKIP_3_Bytes |
| $B2 | := octet |
| $K1_K2 | := octet octet |
| $STS-1_TOH_row6 | := D4_D5_D6 SKIP_3_Bytes |
| $D4_D5_DG | := octet octet octet |
| $STS-1_TOH_row7 | := D7_D8_D9 SKIP_3_Bytes |
| $D7_D8_D9 | := octet octet octet |
| $STS-1_TOH_row8 | := D10_D11_012 SKIP_3_Bytes |
| $D10hd —D11_D12 | := octet octet octet |
| $STS-1_TOH_row9 | := S1_Z1 M0_M1_Z2 E2 SKIP_3_Bytes |
| $S1_Z1 | := octet |
| $M0_M1_Z2 | := octet |
| $E2 | := octet |

Each row of the STS-1 frame is separately defined, such that each time an STS-1 context is called it will be re-entered at the proper location. Each row performs TOH processing, as will be described below, and then performs STS-1_SPE_row processing. The STS-1_SPE_row processing increments to the next context, which could be an IP context, ATM context, etc. The input data interface 910 will signal a context switch back to the STS-1_SPE_row grammar when the POH column is reached, at which time the POH byte is consumed. The STS-1_SPE_row grammar then increments back to the next context until input data interface 910 signals a context switch back to the STS-1_SPE_row grammar when the end of that SPE row is reached. The STS-1_SPE_row grammar then instructs the parser state machine to return to the root grammar with the @ @ Lroot command.

Each set of defined transport overhead bytes is parsed within the appropriate row.

Although not illustrated, several of the transport overhead bytes may be processed with their own sub-grammars, if desired. For instance, the D1 through D12 bytes can be used as another data channel, which could be parsed with an appropriate grammar.

One possible processing approach for TOH row 4 is illustrated. That row contains the POH pointer for the next SPE. The special directive @@XferPointer transfers the two pointer bytes to the appropriate next_POH_pointer register, causing input data interface 910 to assert Pos_Shift, Neg_Shift, or No_Shift back to parser state machine 930. Depending on the state of the asserted variable, either two, three, or four input bytes are then consumed.

Although special-purpose execution engines have been shown and described, alternative implementations can use the described multi-symbol parser as a front-end datagram processor for a general purpose processor. The STS-3 example presented above was used for simplicity—the concepts illustrated therein can be extended, e.g. to parsing STS-12, STS-48, etc., streams formed from any combination of STS-1, STS-3, STS-3c, STS-12, STS-12c, STS-48c streams.

One of ordinary skill in the art will recognize that the concepts taught herein can be tailored to a particular application in many other advantageous ways. Although one set of cooperating parser/input buffer hardware and grammar functionality has been described, others are possible. Also, not every multiple-context parsing approach will need hardware counters, as some parsing problems may contain only context-switching points that can be derived from the input data itself.

Those skilled in the art recognize that other functional partitions are possible within the scope of the invention. Further, what functions are and are not implemented on a common integrated circuit can vary depending on application.

Finally, although the specification may refer to “an”, “one”, “another”, or “some” embodiment(s) in several locations, this does not necessarily mean that each such reference is to the same embodiment(s), or that the feature only applies to a single embodiment.

What is claimed is:

1. An apparatus comprising:
a parser configured to parse a data stream according to a plurality of parsing-contexts, wherein the parser switches parsing-contexts responsive to the semantics of the data stream.

2. The apparatus according to claim 1 wherein the parser parses a first segment of the data stream according to a first parsing-context and a second segment of the data stream according to a second parsing-context.

3. The apparatus according to claim 2 wherein the parser includes a data interface configured to receive segments of the data stream and to count a number of received segments, the parser switches parsing-contexts responsive to the counted number.

4. The apparatus according to claim 1 wherein the parser switches parsing-contexts according to switching symbols identified while parsing the data stream, the switching symbol indicating to the parser a next parsing-context for parsing the data stream.

5. The apparatus according to claim 4 wherein the parser retrieves the switching symbols from the data stream.

6. The apparatus according to claim 4 wherein the parser includes a table interface configured to identify production rule codes within a parser table and retrieve production rules from a production rule table according to the identified production rule codes, where at least one of the production rules includes a switching symbol for indicating to the parser the next parsing-context for parsing the data stream.

7. The apparatus according to claim 1 including
a parser memory configured to store the parsing-contexts; and
a parser state machine configured to control the parsing of the data stream according to the parsing-contexts stored in the parser memory.

8. The apparatus according to claim 7 wherein the parsing-contexts including one or more parsing symbols that direct the parsing of the data stream, the parser state machine switching parsing-contexts by directing the parser to parse the data stream according to parsing symbols from different parsing-contexts.

9. The apparatus according to claim 7 wherein the parser memory includes a plurality of parser stacks to store the parsing symbols, the parser stacks dynamically-sized responsive to the parsing of the data stream.

10. A method comprising:
parsing a data stream according to a plurality of parsing-contexts; and
switching parsing-contexts responsive to the semantics of the data stream.

11. The method of claim 10 wherein the data stream includes a plurality of segments and parsing each segment according to one of a plurality of parsing contexts.

12. The method of claim 11
counting a number of the segments within the data stream; and
switching among the parsing-contexts according to the results of the counting.

13. The method of claim 10 includes
identifying switching symbols during the parsing of the data stream; and
switching parsing contexts responsive to the switching symbols.

14. The method of claim 13 includes identifying the switching symbols within the data stream.

15. The method of claim 10 includes
parsing a first segment of the data stream according to a first parsing context;
switching to a second parsing context responsive to the semantics of the data stream; and
parsing a second segment of the data stream according to the second parsing context.

16. The method of claim 15 includes
switching to a third parsing context responsive to the semantics of the data stream; and
parsing a third segment of the data stream according to the third parsing context.

17. The method of claim 15 includes
switching to the first parsing context responsive to the semantics of the data stream; and
parsing a third segment of the data stream according to the first parsing context.

18. The method of claim 10 includes
populating a parser memory with the plurality of parsing-contexts;
parsing the data stream according to one of the parsing-contexts; and
parsing the data stream according to another parsing-context responsive to the semantics of the data stream.

19. The method of claim 18 wherein the parser memory includes a plurality of parser stacks to store parsing symbols, the parser stacks are dynamically-sized responsive to the parsing of the data stream.

20. A system comprising:
an input buffer for buffering a data stream configured according to a Synchoronous Optical Network (SONET) protocol; and
a direct execution parser configured to parse the data stream according to a plurality of parsing-contexts.

21. The system of claim 20 wherein the input buffer is configured to at least partially de-interleave the data stream and the direct execution parser parses the de-interleaved data stream.

22. The system of claim 21 wherein the data stream including framing data and the input buffer de-interleaves the data stream according to the framing data.

23. The system of claim 20 wherein the direct execution parser switches parsing-contexts responsive to the SONET protocol.

24. The system of claim 20 including
a parser table populated with production rule codes;
a production rule table populated with production rules, wherein the direct execution parser is configured to parse the data stream responsive to production rules retrieved from the production rule table.

25. The system of claim 21 wherein the direct execution parser identifies production rule codes within the parser table and retrieve production rules from the production rule table according to the identified production rule codes.
